(19) United States
(12) Patent Application Publication
(10) Pub. No.: US 2002/0002527 A1
(43) Pub. Date: Jan. 3, 2002

(54) Method for trading goods or services over a network

(76) Inventor: Joel Holtzman, Atlanta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/779,906

(22) Filed: Feb. 8, 2001

Related U.S. Application Data
(60) Provisional application No. 60/181,114, filed on Feb. 8, 2000.

(51) Int. Cl. G06F 17/60

(52) U.S. Cl. 705/37

(57) ABSTRACT

A network based system to facilitate products and services tradeups wherein users can efficiently trade their old or used equipment for the latest models of the same, or different equipment. The invention allows a user or a trading entity to communicate with a service entity over a global network such as the Internet. The service entity will present a user interface to the user for conducting the tradeup and other types of transactions. If the user chooses the tradeup transaction, the user will be prompted to describe used product and the desired product to be traded for the used product. The service entity will search its database for price or value information, based on the description from the user. If the service entity is unable to find information in its database that matches the user descriptions, the service entity will search remote web sites to find the price or value of the used and desired products. The service entity will use this pricing information to give a final transaction price for the tradeup. Upon the user's final instruction, the service entity will execute the tradeup transaction.

### TECHNICAL FIELD

This invention relates to a method for trading goods or services over a network and more particularly, to a method for exchanging used or pre-owned products for more recently released products.

### BACKGROUND OF THE INVENTION

Change (n) 1: small denominations of currency, usually in the form of a coin, that is frequently found in your pocket; 2: a process which results in removing the previously described definition of change from your pocket.

We can't help it, especially in the United States, we must have the latest and greatest or else we are not satisfied in life. Thus, products and services that were purchased in the recent past only provide us satisfaction until the next version is introduced—or at least until our neighbor shows up with it.

The life of products and services within the world in which we live are limited for several reasons. To be competitive and maintain consumer interest, companies are constantly coming out with enhanced products. In addition, as technology advances, newer produces can be built smaller, faster and more feature enhanced. But mainly, the marketers of the world understand our inclination to want the latest and greatest. Thus, slightly used products migrate there way to garage sales, thrift stores, flea markets, pawn shops, closet corners, basements, or even the garbage heap.

One category of products that is increasingly plagued by the above-described phenomenon is electronic devices. Individuals and businesses routinely use electronic devices and equipment on a daily basis. For individuals, some common pieces of electronic equipment or devices include televisions, stereo equipment, telephones, and mobile radiotelephones. Increasingly, individuals are commonly using more advanced electronic devices, such as lap-top computers, desk-top computers, digital cameras, personal data assistants (PDAs), electronic musical equipment, and electronic games. Businesses are perhaps more reliant on electronic equipment and devices such as laptop computers, desktop computers, printers, pagers, networking equipment such as hubs and routers, and other high-end office equipment. Invariably, electronic devices become dated as soon as the next generation of devices are introduced. Electronic devices with new or enhanced functionality, quickly replace what was once state-of-the-art electronics. Electronic devices continue to evolve with each new release having enhanced or additional functionality.

Upon a new release of an electronic device, many users of a prior release will seek to upgrade to the new version. Some users will purchase the new product and abandon their use of the prior product. The prior product, may be given or sold to a friend or may wind up in storage. Other users of a prior release may have the desire to purchase the new release, but may be unable to do so for various reasons. For example, the user may not be able to afford the new product without first selling the old product. Unfortunately, a user's heavy dependency on an electronic device will not allow them to part with their use without having a replacement product immediately available.

Services, similar to products, can quickly become obsolete or less desirable. A typical example can be found in the cellular telephone industry. To gain a reduced price on a cellular telephone handset, a subscriber will often sign up for a multiple year contract. Six months into the contract, the subscriber may find that the terms and conditions of the contract are not compatible with the subscriber's typical use of the cellular telephone service. It would be beneficial if a subscriber could trade his current service agreement in and obtain a new service agreement that is more appropriate for the subscriber.

Therefore, there exists a need in the art for a method in which consumers can more easily exchange products and services, such as electronic devices, for new releases or versions of the products or services. A need furthermore exists for ways in which a consumer can easily purchase a new product and receive a rebate for used items that are subsequently sold. Furthermore, a need exists for ways in which a consumer can more beneficially part with his or her used products and receive discounts on future purchases.

### SUMMARY OF THE INVENTION

In a first embodiment of the present invention, there will exist a website capable of a plurality of transactions (service entity). One transaction type will allow a user to tradeup from a used product to a desired product the user wishes to purchase; usually a newer model that is presently available, or will be in the near future. The user will access the service entity using some communications device with Internet access capabilities. The service entity is preferably menu driven for ease of use, but may take other forms, or use a combination of user interface methods.

The user begins interacting with the service entity by choosing a transaction. If the user chooses the tradeup exchange transaction, the service entity will prompt the user for specified information about the used product. The service entity will also prompt the user to enter information concerning the desired product.

The service entity processes the information from the user concerning the used and desired product. The service entity will utilize its database or seek information from remote web sites, possibly owned by manufacturers or wholesalers, in order to provide a price for the used product. This price method is called an Instant Quote. Likewise, similar resources are utilized by the service entity to provide an Instant Quote of the best price for a desired product, available to the user through the service entity or remote web sites. Subsequently, the service entity will supply a single tradeup exchange price for the transaction. Finally, the user will acknowledge their desire to complete the tradeup exchange and the tradeup exchange will be executed.

### BRIEF DESCRIPTION OF THE DRAWINGS

FIG. 1 is a system diagram that illustrates an exemplary environment suitable for implementing various embodiments of the present invention.

FIG. 2 is a block diagram illustrating the components involved in an exemplary embodiment of the present invention operating to exchange one class of products for a different class of products.

FIG. 3 is a flow diagram illustrating the steps involved in an exemplary embodiment of the present invention operating to perform a tradeup transaction.

FIG. 4 is a flow diagram illustrating the steps involved in a second exemplary embodiment of the present invention operating to perform a tradeup transaction.

FIG. 5 is a flow diagram illustrating the steps involved in a third exemplary embodiment of the present invention operating to perform a tradeup transaction.

### DETAILED DESCRIPTION

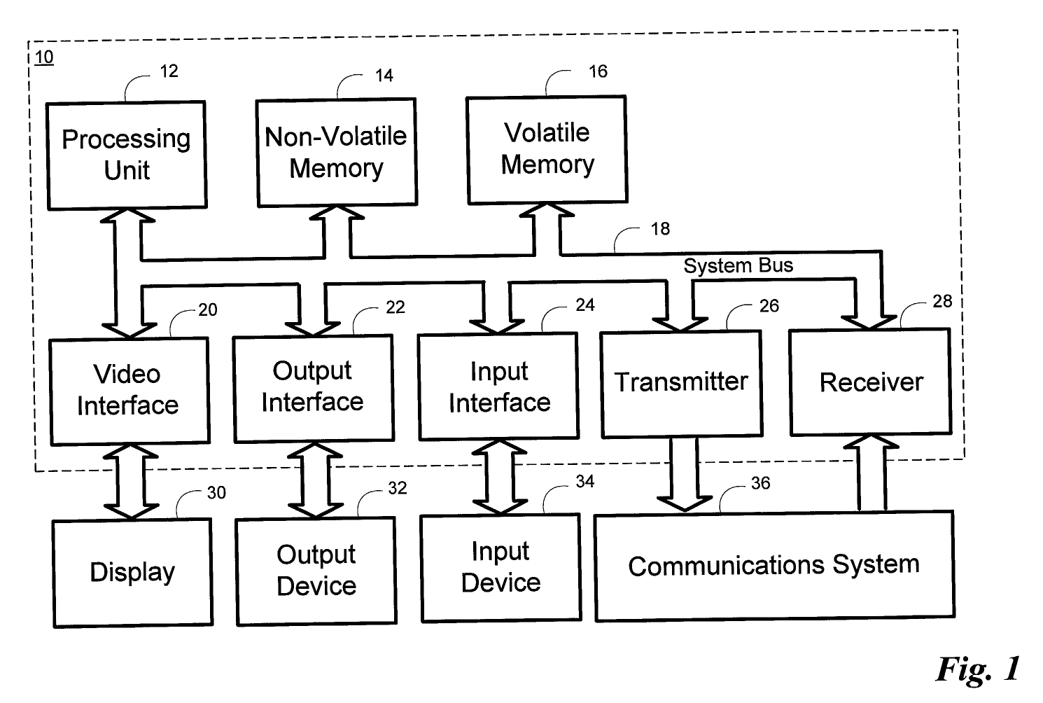

The accompanying drawings, which are incorporated in and form a part of the specification, illustrate embodiments of the present invention and, together with the description, disclose the principles of the invention. FIG. 1 is a system diagram that illustrates an exemplary environment suitable for implementing various embodiments of the present invention. The exemplary system illustrated in FIG. 1 includes an electronic device 10 that is made up of various components including, but not limited to a processing unit 12, non-volatile memory 14, volatile memory 16, and a system bus 18 that couples the non-volatile memory 14 and volatile memory 16 to the processing unit 12. The non-volatile memory 14 may include a variety of memory types including, but not limited to, read only memory (ROM), electronically erasable read only memory (EEROM), electronically erasable and programmable read only memory (EEPROM), electronically programmable read only memory (EPROM), electronically alterable read only memory (EAROM), FLASH memory, bubble memory, and battery backed random access memory (RAM). The non-volatile memory 14 provides storage for power on and reset routines (bootstrap routines) that are invoked upon applying power or resetting the electronic device 10. In some configurations the non-volatile memory 14 provides the basic input/output system (BIOS) routines that are utilized to perform the transfer of information between elements within the various components of the electronic device 10.

The volatile memory 16 may include, but is not limited to, a variety of memory types and devices including, but not limited to, random access memory (RAM), dynamic random access memory (DRAM), FLASH memory, EEPROM, bubble memory, registers, or the like. The volatile memory 16 provides temporary storage for routines, modules, functions, macros, data etc. that are being or may be executed by, or are being accessed or modified by the processing unit 12. In general, the distinction between non-volatile memory 14 and volatile memory 16 is that when power is removed from the electronic device 10 and then reapplied, the contents of the non-volatile memory 14 remain in tact, whereas the contents of the volatile memory 16 are lost, corrupted, or erased.

The electronic device 10 may access one or more external display devices 30 such as a CRT monitor, LCD panel, LED panel, electro-luminescent panel, or other display device, for the purpose of providing information or computing results to a user. In some embodiments, the external display device 30 may actually be incorporated into the product itself. The processing unit 12 interfaces to each display device 30 through a video interface 20 coupled to the processing unit 12 over the system bus 18.

The electronic device 10 may send output information, in addition to the display 30, to one or more output devices 32 such as a speaker, modem, printer, plotter, facsimile machine, RF or infrared transmitter, computer or any other of a variety of devices that can be controlled by the electronic device 10. The processing unit 12 interfaces to each output device 32 through an output interface 22 coupled to the processing unit 12 over the system bus 18. The output interface may include one or more of a variety of interfaces, including but not limited to, an RS-232 serial port interface or other serial port interface, a parallel port interface, a universal serial bus (USB), an optical interface such as infrared or IRDA, an RF or wireless interface such as Bluetooth, or other interface.

The electronic device 10 may receive input or commands from one or more input devices 34 such as a keyboard, pointing device, mouse, modem, RF or infrared receiver, microphone, joystick, track ball, light pen, game pad, scanner, camera, computer or the like. The processing unit 12 interfaces to each input device 34 through an input interface 24 coupled to the processing unit 12 over the system bus 18. The input interface may include one or more of a variety of interfaces, including but not limited to, an RS-232 serial port interface or other serial port interface, a parallel port interface, a universal serial bus (USB), an optical interface such as infrared or IrDA, an RF or wireless interface such as Bluetooth, or other interface.

It will be appreciated that program modules implementing various embodiments of the present invention may be stored in the non-volatile memory 14, the volatile memory 16, or in a remote memory storage device accessible through the output interface 22 and the input interface 24. The program modules may include an operating system, application programs, other program modules, and program data. The processing unit 12 may access various portions of the program modules in response to the various instructions contained therein, as well as under the direction of events occurring or being received over the input interface 24.

The electronic device 10 may transmit signals to, or receive signals from, one or more communications systems 36 such as a cellular network, RF network, computer network, cable network, optical network or the like. The processing unit 12 interfaces to each communications system 36 through a transmitter 26 and a receiver 28, both coupled to the processing unit 12 over the system bus 18. The transmitter 26 and the receiver 28 may include one or more of a variety of transmission techniques such as a radio frequency interface (AM, FM, PSK, QPSK, TDMA, CDMA, Bluetooth or other technique) or an optical interface such as infrared or IrDA.

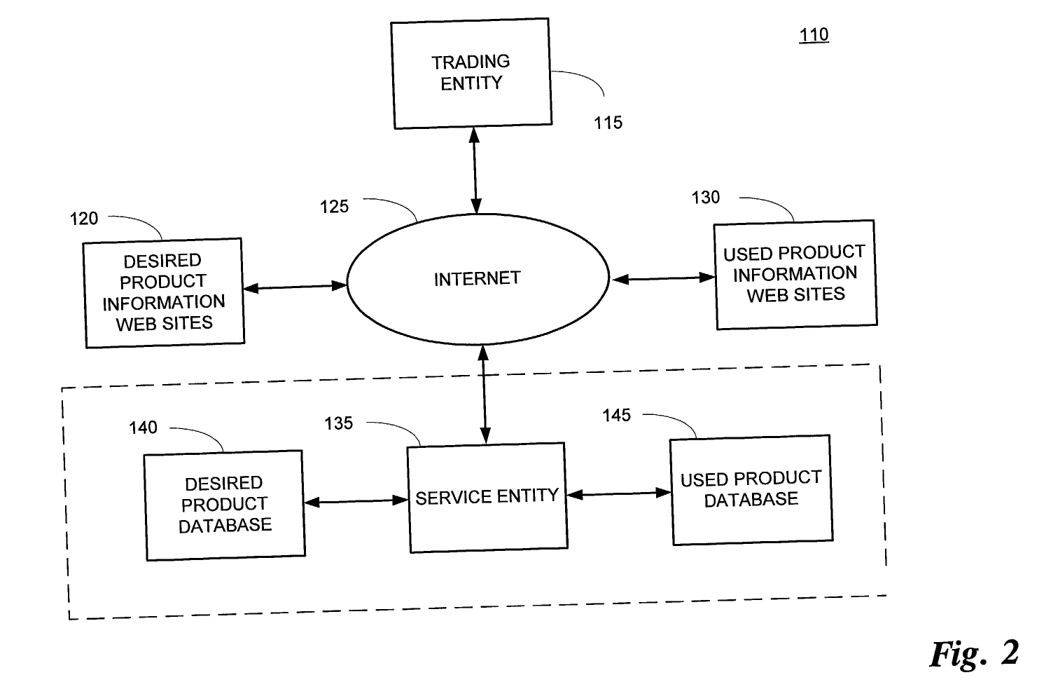

FIG. 2 is a block diagram illustrating the components involved in an exemplary embodiment of the present invention operating to exchange one class of products for a different class of products. The overall system 110 includes various components which operate together to exchange a product in a first class for a product in a second class, sell a product for credit toward later purchases, or provide rebates associated with the purchase of products whenever a product is subsequently sold using the present invention.

The main components in an exemplary embodiment of the present invention include a trading entity 115, a service entity 135 and a connection means 125 that allows that trading entity 115 to communicate with the service entity 135. The trading entity 115 represents any entity that uses embodiments of the invention. Although this component is described as a user, it could also include a computer running a program module. The trading entity 115 accesses the service entity 135 through the connection means 125. In the preferred embodiment, the network means is a global communications system such as the Internet, or a more local based intranet network. However, it should be understood that the various aspects of the present invention can equally be applied in other types of configurations including private networks, satellite and the like. In this embodiment, the service entity 135 is most appropriately described as a web service. The service entity 135 provides an interface for interacting with the trading entity 115. The service entity 135 has access to and can search a desired product database 140 and a used product database 145.

Although the databases are shown as two separate databases, the actual information can be included in a single database or multiple databases, and exist on a single platform or be spread across several platforms. More generally speaking, the databases may represent various classes of products and services and the present invention is not limited to used and desired classes. Additional classes include, but are not limited to power efficiency ratings, age range for typical users (i.e., products for infants versus products for toddlers), weight of the product, aesthetic attributes, or the like. In the addition, although the present invention is described as being used to trade used or old products for newer products, the reader will realize that the reverse is also true. A party experiencing cognitive dissonance after purchasing the latest and most expensive product may want to trade the product for an older less expensive product and obtain a refund or credit for the left over balance.

For purposes of simplicity, the databases will be described as a used product database database 145 and a desired product database 140. The used product database 145 contains information, from which the service entity 135 may draw, to search for a correlation to product information provided by the trading entity 115. Similarly, the desired product database 140 may be searched by the service entity 135 to check for a correlation between the desired product information, provided by the trading entity 115, and the database 140 stored information concerning the desired products.

In addition to the databases, information pertaining to the products and services can be obtained from other sources. In the Internet or intranet based embodiments, one such source can include other web sites or web services. For instance, in a particular embodiment, one or more desired product information web sites 120 and used product information web sites 130 may be maintained and accessed via the Internet or intranet.

The desired product information web sites 120 are web sites that may be utilized to search for the current price for a desired product. The service entity 135 has access to these desired new product information web sites 120. The desired product information web sites 120 are normally only searched if the desired product database 140 does not contain a correlation with the desired product information provided by the trading entity 115. Likewise, the service entity 135 may search the used product information web sites 130. This is usually only done if there is no correlation with the information provided by the trading entity 115 and the used product information stored in the used product database 145. Both the desired product information web sites 120 and the used product information web sites 130 are part of the remote web sites available to the invention to search for price/value information.

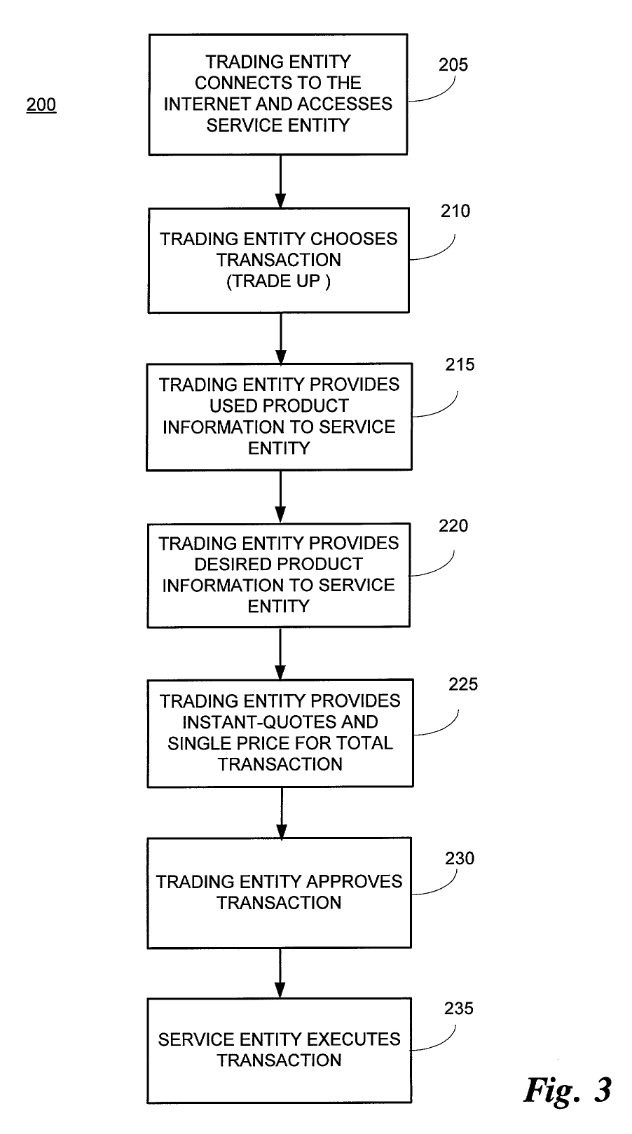

FIG. 3 is a flow diagram illustrating the steps involved in an exemplary embodiment of the present invention operating to perform a tradeup transaction. Flow diagram 200 shows the steps of a first embodiment of the present invention. At step 205, the trading entity 115 will access the Internet or intranet 125. This access may be done using any number of ways to access the Internet 125 and allows trading entity 115 to access and communicate with the service entity 135. The service entity 135 offers a plurality of services for the trading entity 115 to choose from, though other embodiments may only offer one specific service. Once the trading entity 115 has connected to the service entity 135 processing continues at step 210.

At step 210, the trading entity 115 chooses a transaction to be performed (i.e., tradeup exchange transaction). Other choices available to the trading entity 115 in this embodiment may include selling, selling for credit, tradedown, buying, buying with an associated rebate, or other transactions). In response to choosing a particular transaction, the service entity 135 instructs the trading entity 115 proceed. When the trading entity 115 is a human user, the interface to the service entity 135 may include pull-down menus, screen menus, charts, graphs and other forms of user interface methods. Once the transaction has been selected, processing continues at step 215.

At step 215 the service entity 135 prompts the trading entity 115 for information related to the tradeup exchange (i.e., information related to the used product to be traded). The information concerning the used product may vary, but in one embodiment comprises the following elements: type, quantity, manufacturer, model number, added upgrades, age, status of the warranty, and product condition. Once the used product information is provided, processing continues at step 220.

At step 220, the service entity 135 prompts the trading entity 115 for additional information relating to the tradeup exchange (i.e., information concerning the desired product). Information about the desired product in this embodiment comprises the following elements: type/category, quantity, manufacturer, and product model number. Those skilled in the pertinent art will realize the items in the used and desired product information list are in no way meant to be mandatory or exhaustive in nature. Once the desired product information is provided, processing continues at step 225.

At step 225, the service entity 135 will process the received information to obtain a price/value quote for the used and desired products (Instant Quote price). In one embodiment of the present invention, a warning indicator will be provided to the trading entity 115 indicating that the Instant Quote price for the used product is being provided based on the information provided by the trading entity 115, and the service entity 135 retains the right to refuse to honor this price if the information provided is false. To obtain the Instant Quote, the service entity 135 will initially search for a correlation between information stored in its used product database 145 and the used product information provided by the trading entity 115. If a correlation is found, the service entity 135 will use this information to provide an Instant Quote price for the used product. However, if there is no correlation, the service entity 135 will search for used product information on the used product information web sites 130, in accordance with the description provided by the trading entity 115. Information found using the used product information web sites 130 may be used to provide an Instant Quote to the trading entity 115. For instance, the used product data may comprise Blue Book values of the used products as provided by any suitable source, such as the Blue Book values provided by Orion Research of Scottsdale, Ariz. The used product information may also be derived from other remote web sites, including brokers, exporters, or at other portals, such as one selling used products. In addition the service entity 135 will search the desired product database 140 for a correlation between its information and the desired product information provided by the trading entity 115. If a correlation exists, the desired product database is used to provide an Instant Quote price for the desired product. If no correlation exists, the service entity 135 will search the desired product information web sites 120 to generate an Instant Quote price for the desired product.

In alternative embodiments, the service entity 135 updates the used product database 145 for future usage if the used product information web sites 130 are used to generate the Instant Quote. Both the used and desired product information web sites are included in the remote web sites utilized by the invention to provide Instant Quotes. The service entity 135 may acquire the used product and new product information in any suitable manner.

In the illustrated embodiment, the service entity 135 also calculates a single price for this transaction at step 225. The single price for the transaction represents the amount that the trading entity 115 will pay when the price of the used item is less than the desired items or for which credit will be received by the trading entity 115 when the price of the used item is more than the price of the desired item. Thus, the single price will depend on the Instant Quote prices for the used and desired products. Once the Instant Quote is provided, processing continues at step 230.

After the service entity 135 calculates a single price for this transaction, the service entity 135 will prompt the trading entity 115 for permission to complete the transaction at step 230. The trading entity 115 may use various means to indicate that the transaction is approved and the service entity would preferably acknowledge the approval from the trading entity 115. Once the transaction is approved, processing continues at step 235.

Finally, at step 235, the service entity 135 will execute the tradeup exchange transaction. In the illustrated embodiment, this may involve instructing the trading entity 115 how to send the used product to the facility and how the desired product will be received. The service entity 135 may provide confirmation numbers or exclusive access codes to the trading entity 115. The service entity 135 may also generate an order to a warehouse or supplier to obtain the desired product. The variations included in the execution of the tradeup exchange may vary in accordance with the needs of the trading entity 115 and the different embodiments of the present invention.

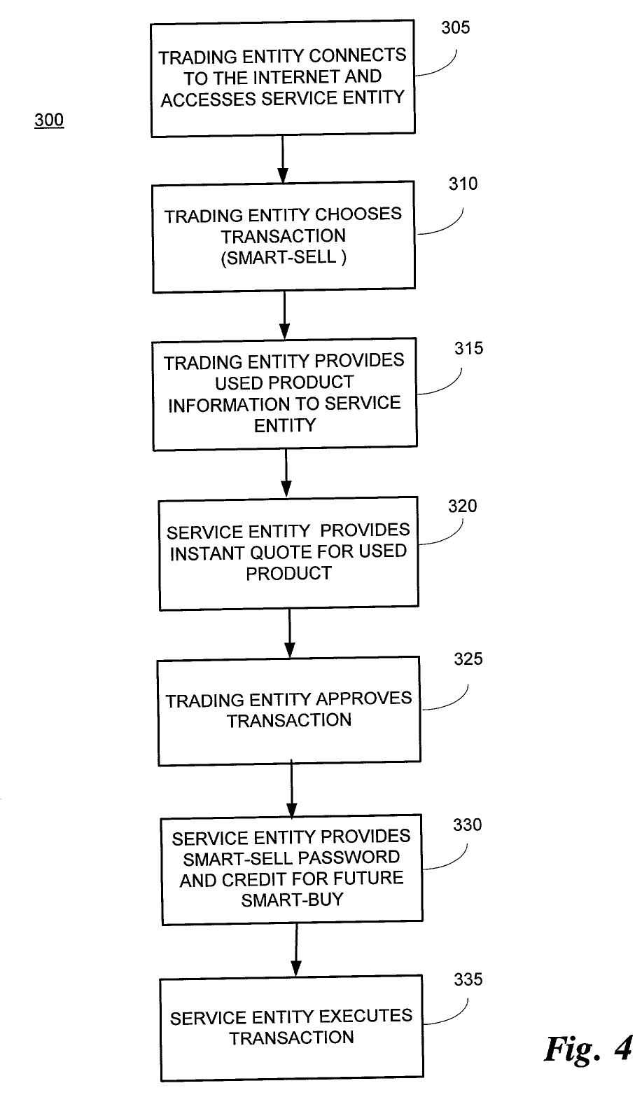

FIG. 4 is a flow diagram illustrating the steps involved in a second exemplary embodiment of the present invention operating to perform a tradeup transaction. A smart-sell is a sell comprised of the ability to obtain a credit for the sale of a used product, which may be used at some future time to purchase a desired product during a smart-buy. At step 305, the trading entity 115 will access the Internet 125 and will communicate with the service entity 135. Processing then continues at step 310.

At step 310, the trading entity 115 chooses the smart-sell transaction. Other choices may or may not be available to the trading entity 115 in this alternative embodiment. Processing then continues at 315.

At step 315 the service entity 135 prompts the trading entity 115 for information related to the smart-sell, (i.e., information related to the used product). Similar to the embodiment illustrated in FIG. 2, the information concerning the used product may vary. Processing continues at step 320.

At step 320, the service entity 135 utilizes its database resources and remote web sites to calculate an Instant Quote. The service entity 135 initially searches for a correlation between information stored in its used product database 145 and the used product information provided by the trading entity 115. If a correlation is found, the service entity 135 will use this information to provide an Instant Quote price for the used product. However, if there is no correlation, the service entity 135 will search for used product information on the used product information web sites 130, in accordance with the description provided by the trading entity 115. Thus, the information found using the used product information web sites 130 is used to provide an Instant Quote to the trading entity 115 if no corresponding information is found in the used product database 145. Processing then continues at step 325.

At step 325, after the Instant Quote is provided for this transaction, the service entity 135 will prompt the trading entity 115 for permission to complete the transaction. The trading entity 115 may use various means to indicate that the transaction is approved and the service entity 135 would preferably acknowledge the user's 115 approval from the trading entity 115. Processing then continues at step 330.

At step 330, the service entity 135 provides a smart-sell password and credit for a future smart-buy. Thus, with this password or other unique information associated with this transaction, a trading entity 115 may make a smart-buy and receive a credit toward that purchase in proportion to his/her previous smart-sell. A smart-buy and smart-sell are buys and sells associated with the procedure of this invention. Processing then continues at step 335.

Finally, at step 335, the service entity 135 executes the smart-sell transaction. In alternative embodiments, a smart-sell can be invoked but the trading system, rather than issuing a credit at that time will just keep the transaction open for a period of time. If a trading entity 115 does not make a subsequent purchase request during that period of time, then the Instant Quote for the smart-sell will expire. In another embodiment, the value of the Instant Quote can decay over time. Thus, if a trading entity 115 invokes a smart-sell, then the longer the trading entity 115 delays before invoking a smart-buy, the lower the value of the Instant Quote will be.

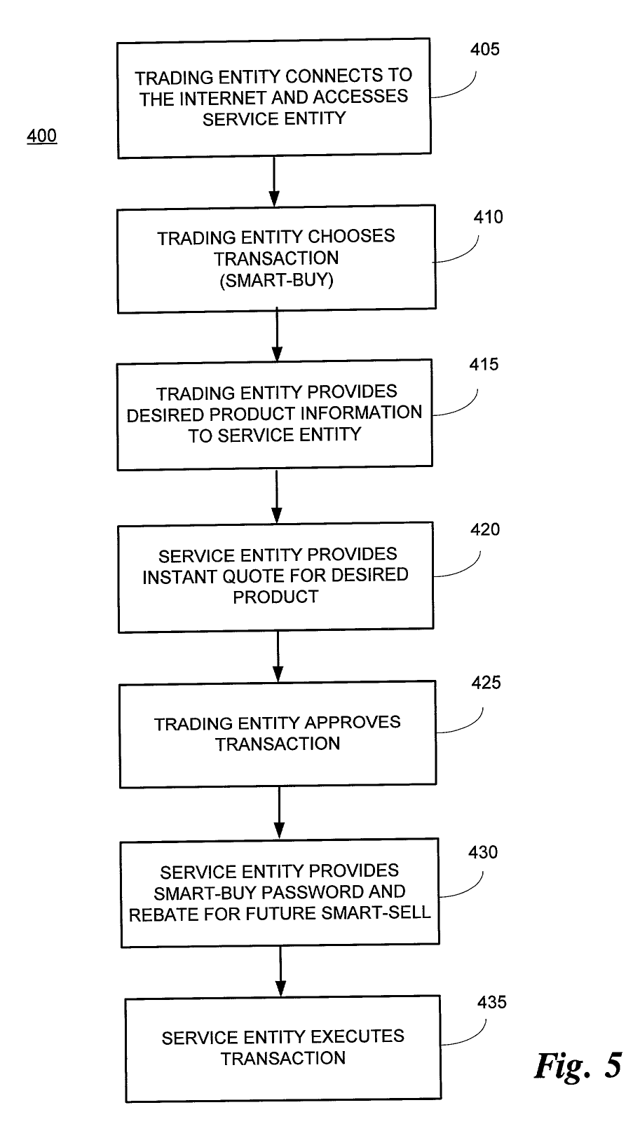

FIG. 5 is a flow diagram illustrating the steps involved in a third exemplary embodiment of the present invention operating to perform a tradeup transaction. In this embodiment, though similar to the embodiment disclosed in FIG. 4, the desired product is purchased first using a smart-buy, and a rebate is given when a smart-sell occurs associated with the smart-buy. Flow diagram 400 shows the steps involved in this embodiment of the invention, which features the ability to give a rebate after a smart-sell associated with a prior smart-buy. At step 405, the trading entity 115 accesses the Internet or intranet 125 and communicates with the service entity 135. Processing then continues at step 410.

In the illustrated embodiment, at step 410, the trading entity 115 chooses the smart-buy transaction. Other choices may or may not be available to the trading entity 115 in this embodiment. Processing then continues at step 415.

At step 415 the service entity 135 prompts the trading entity 115 for information related to the smart-buy, (i.e., information related to the desired product). Similar to the embodiment illustrated in FIG. 2, the information concerning the desired product may vary. Processing then continues at step 420.

At step 420, the service entity 135 utilizes the service entity resources and remote web sites to calculate an Instant Quote. The service entity 135 initially searches for a correlation between information stored in its desired product database 120 and the desired product information provided by the trading entity 115. If a correlation is found, the service entity 135 uses this information to provide an Instant Quote price for the desired product. However, if there is no correlation, the service entity 135 searches for desired product information on the desired product information web sites 120, in accordance with the description provided by the trading entity 115. Thus, the information found using the desired product information web sites 120 is used to provide an Instant Quote to the trading entity 115 if no corresponding information is found in the desired product database 140. Processing then continues at step 425.

After the Instant Quote is provided for this transaction, the service entity 135 prompts the trading entity 115 for permission to complete the transaction at step 425. The trading entity 115 may use various means to indicate that the smart-buy transaction is approved. Processing then continues at step 430.

At step 430, the service entity 135 provides a smart-buy password and stores a rebate amount for the trading entity 115 that can be applied future smart-sell. Thus, with this password or other unique information associated with this transaction, a trading entity 115 may make a future smart-sell and receive a rebate from a previous smart-buy in proportion to his/her previous smart-buy. Other embodiments may award a standard rebate amount for each smart-sell associated with a previous smart-buy. Processing then continues at step 435 when the transaction is executed. Alternative embodiments will allow various time limits, or unlimited time between the smart-buy and smart-sell.

Finally, at step 435, the service entity 135 will execute the smart-buy transaction.

The foregoing description of the preferred embodiments of the invention has been presented only for the purpose of illustration and description and is not intended to be exhaustive or to limit the invention to the precise forms disclosed. Many modifications and variations are possible in light of the above teaching.

For example, while the embodiment described in FIG. 2 focuses on electronic devices or equipment, it should be understood that the invention encompasses other types of products and services. The products may include such goods as jewelry, sporting goods, automobiles, furniture, etc. Furthermore, trading entity 115 are able to exchange or trade goods for dissimilar goods, such as exchanging an automobile for furniture.

Alternate embodiments will become apparent to those skilled in the art to which the present invention pertains without departing from its spirit and scope. Accordingly, the scope of the present invention is described by the appended claims and supported by the foregoing description.

What is claimed is:

1. A method to exchange a first product for a second product using an Internet based service entity, the method comprising the steps of:
accessing said service entity utilizing the Internet;
selecting a tradeup transaction available from said service entity;
receiving a request from said service entity for information related to said tradeup transaction;
providing said service entity with said requested information; and
said service entity executing said tradeup transaction.

2. The method of claim 1, wherein said step of providing said service entity with said requested information comprises the steps of:
providing information regarding said first product, wherein said information comprises at least one of the following elements:
(a) product type;
(b) quantity;
(c) manufacturer;
(d) model number;
(e) implemented upgrades;
(f) age;
(g) status of warranty;
(h) condition; and
providing information regarding said second product, wherein said information comprises at least one of the following elements:
(a) product type;
(b) quantity;
(c) manufacturer; and
(d) model number.

3. The method of claim 2, wherein said step of said service entity executing said tradeup transaction further comprises the service entity performing the steps of:
providing an Instant Quote price for said first product, based at least in part on said information regarding said first product; and
providing an Instant Quote price for said second product, based at least in part on said information regarding said second product.

4. The method of claim 3, wherein said service entity is operable to access a product database and a remote product web site, and said step of providing an Instant Quote price for said first product further comprises the steps of:
comparing said information regarding said first product to product information located in said product database;
if said comparison identifies a correlation, utilizing said product information located in said product database in providing said Instant Quote price for said first product;
if a correlation is not identified, utilizing said product information available at said remote product web site to provide said Instant Quote price for said first product.

5. The method of claim 4, further comprising the step of updating said product database with information from said remote product web site, if said remote product web site is utilized to provide the Instant Quote price.

6. The method of claim 3, wherein said service entity is operable to access a product database and remote product web site, and said step of providing said Instant Quote for said second product further comprises the steps of:
comparing said information regarding said second product to product information in said product database;
if said comparison identifies a correlation, utilizing said product database to provide said Instant Quote price for said desired product;
if said comparison does not identify a correlation, utilizing said remote product web site to provide said Instant Quote price for said desired product.

7. The method of claim 6, further comprising the step of updating said product database with information from said remote product web site, if said remote product web site is used to provide the Instant Quote price for said second product.

8. The method of claim 3, wherein having generated said Instant Quote price for said first product and said Instant Quote price for said second product, said step of said service entity executing said tradeup transaction further comprises the step of said service entity providing a single price for said tradeup exchange.

9. The method of claim 8, wherein said step of said service entity executing said tradeup transaction further comprises the step of said service entity prompting for approval to execute said tradeup and receiving an affirmative response to said prompt.

10. A computer-readable medium having computer executable instructions for performing the steps recited in claim 3.

11. A computer-readable medium having computer executable instructions for performing the steps recited in claim 4.

12. A computer-readable medium having computer executable instructions for performing the steps recited in claim 5.

13. A computer-readable medium having computer executable instructions for performing the steps recited in claim 6.

14. A computer-readable medium having computer executable instructions for performing the steps recited in claim 7.

15. A computer-readable medium having computer executable instructions for performing the steps recited in claim 8.

16. A computer-readable medium having computer executable instructions for performing the steps recited in claim 9.

17. A method to sell a product using an Internet based service entity, wherein the service entity offers a plurality of transactions to execute the sell, the method comprising the steps of:
accessing said service entity utilizing the Internet;
selecting a smart-sell transaction available from said service entity;
receiving a request from said service entity for information related to said smart-sell transaction;
providing said service entity with said requested information; and
said service entity executing said smart-sell transaction.

18. The method of claim 17, wherein said step of providing said service entity with said requested plurality of information comprises the step of providing information regarding said product, and said information comprises at least one of the following elements:
(a) product type;
(b) quantity;
(c) manufacturer;
(d) model number;
(e) implemented upgrades;
(f) age;
(g) status of warranty; and
(h) condition.

19. The method of claim 18, wherein said step of said service entity executing said smart-sell transaction further comprises the service entity performing the step of providing an Instant Quote price for said product, based at least in part on said information regarding said product.

20. The method of claim 19, wherein said service entity is operable to access a product database and a remote product web site, and said step of providing an Instant Quote price for said product further comprises the following steps:
comparing said information regarding said product to product information located in said product database;
if said comparison identifies a correlation, utilizing said product information located in said product database in providing said Instant Quote price for said product; and
if a correlation is not identified, utilizing said product information available at said remote product web sites to provide said Instant Quote price for said product.

21. The method of claim 20, further comprising the step of updating said product database with information from said remote product web site, if said remote product web site is utilized to provide the Instant Quote price.

22. The method of claim 19, wherein said step of said service entity executing said smart-sell transaction further comprises the step of said service entity prompting for approval to execute said smart-sell and receiving an affirmative response to said prompt.

23. The method of claim 22, wherein said step of said service entity prompting for approval to execute said smart-sell and receiving an affirmative response, comprises the following steps:
providing a unique smart-sell password; and
providing credit toward a smart-buy, wherein said credit is provided when said unique smart-sell password and said smart-buy are utilized in conjunction.

24. A computer-readable medium having computer executable instructions for performing the steps recited in claim 19.

25. A computer-readable medium having computer executable instructions for performing the steps recited in claim 20.

26. A computer-readable medium having computer executable instructions for performing the steps recited in claim 21.

27. A computer-readable medium having computer executable instructions for performing the steps recited in claim 22.

28. A computer-readable medium having computer executable instructions for performing the steps recited in claim 23.

29. A method to purchase a product using an Internet based service entity, wherein the service entity offers a plurality of transactions to execute the purchase, the method comprising the steps of:
accessing said service entity utilizing the Internet;
selecting a smart-buy transaction available from said service entity;
receiving a request from said service entity for information related to said smart-buy transaction;
providing said service entity with said requested information; and
said service entity executing said smart-buy transaction.

30. The method of claim 29, wherein said step of providing said service entity with said requested plurality of information comprising the step of providing information about said product, and said information comprises at least one of the following elements:
(a) product type;
(b) quantity;
(c) manufacturer; and
(d) model number.

31. The method of claim 30, wherein said step of said service entity executing said smart-buy transaction further comprises the service entity performing the step of providing an Instant Quote price for said product, based at least in part on said information regarding said product.

32. The method of claim 31, wherein said service entity is operable to access a product database and a remote product web site, and said step of providing an Instant Quote price for said product further comprises the following steps:
comparing said information regarding said product to product information located in said product database;
if said comparison identifies a correlation, utilizing said product information located in said product database in providing said Instant Quote price for said product; and
if a correlation is not identified, utilizing said product information available at said remote product web site to provide said Instant Quote price for said product.

33. The method of claim 32, further comprising the step of updating said product database with information from said remote product web site, if said remote product web site is utilized to provide the Instant Quote price.

34. The method of claim 29, wherein said step of said service entity executing said smart-buy transaction further comprises the step of said service entity prompting for approval to execute said smart-buy and receiving an affirmative response to said prompt.

35. The method of claim 34, wherein said step of said service entity prompting for approval to execute said smart-buy and receiving an affirmative response, comprises the following steps:
providing a unique smart-buy password; and
providing a rebate for a future smart-sell, wherein said rebate is provided when said unique smart-buy password and said smart-sell are utilized in conjunction.

36. A computer-readable medium having computer executable instructions for performing the steps recited in claim 31.

37. A computer-readable medium having computer executable instructions for performing the steps recited in claim 32.

38. A computer-readable medium having computer executable instructions for performing the steps recited in claim 33.

39. A computer-readable medium having computer executable instructions for performing the steps recited in claim 34.

40. A computer-readable medium having computer executable instructions for performing the steps recited in claim 35.

41. A system for exchanging a first product for a second product over a global network, the system comprising:
a trading entity;
a service entity;
a database communicatively coupled to said service entity;
the trading entity being operative to:
send a tradeup request to said service entity;
in response to receiving a request for a first product information and a second product information for said service entity, the first product information representing a product to be traded and the second product information representing a product to be acquired, providing said first product information and said second product information;
in response to receiving an Instant Quote from said service entity, confirming the execution of said tradeup;
the service entity being operative to:
in response to receiving said trade request, provide said first product information request and said second product information request to said trading entity;
in response to receiving said first product information and said second product information, accessing said database to identify pricing information for said first product and said second product, said pricing information being used to generate said Instant Quote and providing said Instant Quote to said trading entity; and
in response to receiving a confirmation of the tradeup from said trading entity, executing the tradeup.

42. A service system, wherein said service system is a computer system for exchanging a first product for a second product over a global network, the computer system comprising:
an input for receiving information from a trading entity, wherein said information is related to a first product, a second product, and a tradeup request, the first product information representing a product to be traded and the second product information representing a product to be acquired;
a central processing unit for processing said first product information, said second product information, and said tradeup request, wherein said processing comprises:
comparing a database for information that correlates to said first product information and said second product information;
if said comparison identifies a correlation to said product information, utilizing said product information located in a product database in providing an Instant Quote price for said product;
if a correlation is not identified, utilizing said product information available at said remote product web site to provide said Instant Quote price for said product;
executing said tradeup request; and
an output for providing results of said processing to said trading entity.
